(19) United States
(12) Patent Application Publication
(10) Pub. No.: US 2025/0037920 A1
(43) Pub. Date: Jan. 30, 2025

(54) Tape-Wound Ring Core with Isotropic Magnetic Bridge

(71) Applicant: Vacuumschmelze GmbH & Co. KG, Hanau (DE)

(72) Inventors: Joachim Gerster, Hanau (DE); Albert Georges Kougang Kengni, Hanau (DE); Johannes Binkofski, Hanau (DE); Harald Hundt, Hanau (DE)

(21) Appl. No.: 18/782,192

(22) Filed: Jul. 24, 2024

(30) Foreign Application Priority Data
Jul. 24, 2023 (DE) 102023119519.0

(51) Int. Cl. H01F 27/24; H01F 27/30

(52) U.S. Cl. CPC H01F 27/24; H01F 27/306

(57) ABSTRACT

An embodiment relates to a ring core assembly. The ring core assembly includes a ring core wound from a ferromagnetic tape and at least one flux guide piece. The at least one flux guide piece is arranged laterally on the ring core so as to (mechanically) contact narrow sides of a plurality of tape layers of the ring core.

### RELATED APPLICATIONS

The instant application claims priority to German Patent Office Application 102023119519.0 filed on Jul. 24, 2023, the content of said application being incorporated by reference herein in its entirety.

### TECHNICAL FIELD

The present description relates to a ring core assembly that may be used, for example, for current-compensated chokes.

### BACKGROUND

Ringcore assemblies are required for many applications and may have a crosspiece of ferromagnetic material inserted into the central opening of the ring core. Such ring core assemblies are used, for example, for the construction of filter chokes such as common-mode chokes (CMCs) or differential-mode chokes (DMCs). The ring core is not necessarily circular, but often has an oval shape. The term “ring” does not imply a specific shape (such as circular or oval), but simply states that the core runs along a closed curve. Typically, ring cores are made by winding a ferromagnetic tape and are therefore also referred to as tape wound ring cores.

Filter chokes (e.g., CMCs or DMCs) having a ring core with a ferromagnetic crosspiece inserted in the central opening to guide the magnetic flux may have unsatisfactory performance in practice, i.e., the magnetic properties of the filter choke do not meet expectations.

The inventors set themselves the objective to improve known concepts for the design of ring core assemblies, in particular for use in filter chokes.

### SUMMARY

One embodiment relates to a ring core assembly. The ring core assembly comprises a ring core wound from a ferromagnetic tape and at least one flux guide piece. The flux guide piece is arranged laterally on the tape-wound ring core such that it (mechanically) contacts the narrow sides of a plurality of tape layers of the tape-wound ring core.

Another embodiment relates to a filter choke having a ring core wound from a ferromagnetic tape and having two coils wound around the ring core. The filter choke further comprises at least one flux guide piece disposed between the two coils, and further disposed laterally on the tape-wound ring core such that the flux guide piece contacts the narrow sides of a plurality of tape layers of the tape-wound ring core.

### BRIEF DESCRIPTION OF THE DRAWINGS

Various embodiments are described in more detail below with reference to drawings. The drawings are not necessarily to scale and the invention is not limited to the aspects illustrated. Rather, emphasis is placed on illustrating the principles underlying the illustrated embodiments.

FIG. 1 illustrates (a) a plan view and (b) a perspective view of a ring core assembly having an oval ring core with a crosspiece of ferromagnetic material inserted into the central opening.

FIG. 2 illustrates magnetic saturation effects that may occur in the ring core assembly of FIG. 1.

FIG. 3 illustrates a segment of ferromagnetic tape from which the ring core of FIG. 1 is wound.

FIG. 4 illustrates a ring core assembly comprising a ring core wound of the ferromagnetic tape of FIG. 3 and a flux guide piece mounted on the side of the ring core.

FIG. 5 illustrates a ring core assembly similar to that of FIG. 4 but with two flux guide pieces symmetrically arranged on the ring core.

FIG. 6 shows a combination of the examples in FIGS. 5 and 1 as a further example embodiment.

FIG. 7 illustrates an alternative to FIG. 4.

FIG. 8 illustrates another embodiment in which the flux guide piece is mounted on the side of the ring core and runs through the central opening of the core.

FIG. 9 illustrates several variants/alternatives to the example in FIG. 8.

FIG. 10 illustrates the use of the ring core assembly described herein for the construction of filter chokes.

FIG. 11 illustrates an example of a ring assembly for a multiphase system.

### DETAILED DESCRIPTION

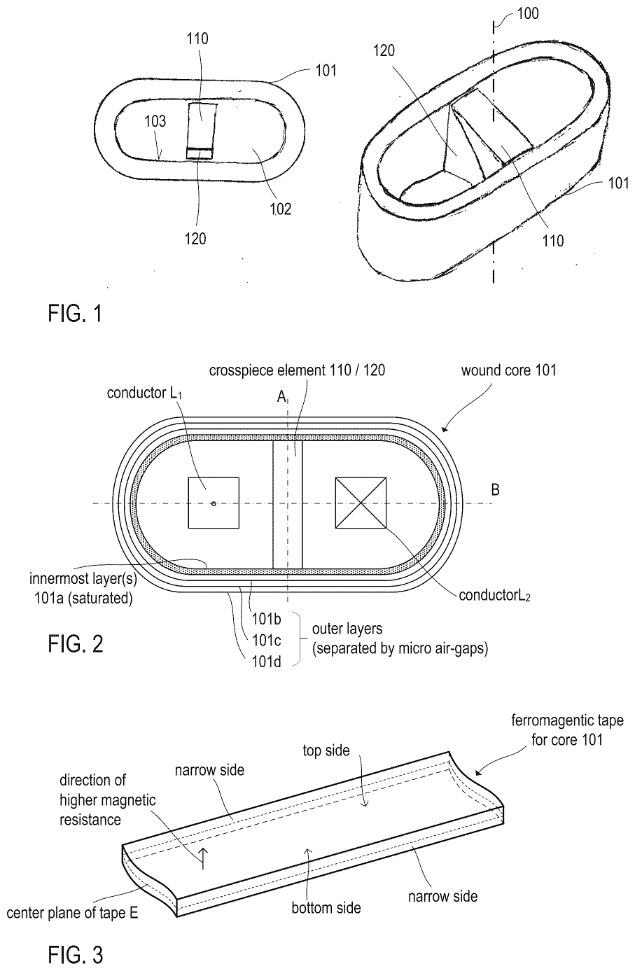

FIG. 1 shows a plan view (left view) and a perspective view (right view) of an exemplary ring core assembly having an oval ring core 101 with a crosspiece of ferromagnetic material inserted into its central opening 102 (which is bounded by the ring core 101). The ring core has (at least) two axes of symmetry A and B. In the illustrated example of an oval core, the oval contour of the core has exactly two axes of symmetry. The crosspiece is also referred to as flux guide piece. As mentioned, the term “oval” generally refers to a roundish shape, but it does not necessarily have to be elliptical. In this context, a rectangle or a square with a rounded corner may also be an oval. A circle is a special case of the generic term “oval”. As a rule, an oval has at least two axes of symmetry that intersect at a center point.

In the illustrated example, the flux guide piece comprises two crosspiece elements 110 and 120. These crosspiece elements are prism-shaped with a triangular base. In other words, the crosspiece elements 110, 120 have the shape of wedges that slide against each other. When assembled, the crosspiece elements 110, 120 form approximately a cuboid shape. Due to the wedge shape of the crosspiece elements 110, 120, very small air gaps between the crosspiece elements 110, 120 and the inner wall 103 of the ring core 101 can be achieved and manufacturing tolerances can be compensated. The remaining (and unavoidable) air gap is determined by any coatings present on the tape material from which the ring core is made as well as by its surface roughness. Typically, air gaps of less than 10 μm can be achieved.

As mentioned at the beginning, it has turned out in practice that the actual magnetic properties of the core- and thus the properties of the filter chokes built with it—are worse than expected when applying usual design rules. In the following, FIG. 2 is used to explain the problem that is presumably responsible for the deteriorated properties of the filter chokes. It is understood that FIG. 2 is only a simplified, not to scale, schematic representation. The ring core 101 shown in FIG. 2 has four superimposed layers. As mentioned, the illustration is highly simplified (but sufficient to explain the problem). In reality, a ring core has hundreds of layers formed by winding a ferromagnetic tape. The conductors L₁ and L₂ shown in FIG. 2 are bus bars passing through the ring core. The direction of current is symbolized by the dot (·) and the cross (×). That is, in FIG. 2 one can see the cross-section of the conductors, the current direction is perpendicular to the drawing plane. The dot symbolizes that the current flows out of the drawing plane, and the cross symbolizes that the current flows into the drawing plane. The conductors L₁ and L₂ may also be interpreted as windings with a single turn. In some embodiments, windings with a plurality of turns may also be used (see also FIG. 10).

The tape, of which the ring core 101 is made of, may have a thickness in the range of 10-1000 μm (typically, for example, 20 μm). The tape also has a coating, for example, of aluminum oxide, zirconium oxide, magnesium oxide, and/or silicon oxide. A suitable material is, for example, a nanocrystalline iron alloy, which may contain, for example, portions of silicon, niobium, boron and copper. A specific example of a suitable alloy is VITROPERM®. The relative permeability uᵣ of the tape material may be adjusted to specific μᵣ values between 100 and 1,000,000 by varying the alloy composition and annealing, depending on the requirements (i.e., depending on the desired application).

In particular, for alloys with relatively high silicon content (e.g., 5-10 weight percent), the formation of a silicon oxide layer on the surface is practically unavoidable. Due to the mentioned coating (e.g. SiO₂) as well as due to an unavoidable surface roughness, gaps in the order of a few micrometers (e.g. 2-10 μm) remain between the layers when the tape is wound up into a tape-wound ring core. Even if there is not only air in these gaps, they are called “air gaps” because they behave magnetically like air gaps.

The tape has a top side, a bottom side and two (narrow, only a few μm wide) side faces. During winding-up, the top side of one layer adjoins to the bottom side of the layer above. For the reasons explained above, an air gap of a few micrometers (referred to as a micro air gap in FIG. 2) remains between the top and bottom of two adjacent layers. In the simplified model of FIG. 2, the air gaps are located between the layers 101a-d of the ring core.

Studies have surprisingly shown that in practice, at comparatively high electric currents (flowing through coils L₁, L₂ wound around the core (or through a coil wound around the crosspiece 110, 120) thus causing a magnetic flux in the crosspiece 110, 120), the ring core does not saturate uniformly, but magnetic saturation occurs first in the innermost layer (or in a few of the inner layers). In FIG. 2, the magnetic saturation in the innermost tape layer is visualized by the gray shading.

Due to the mentioned micro air gaps between the individual tape layers, the tape-wound ring tape core becomes magnetically anisotropic. Within a tape layer, the relative permeability is very high and the magnetic resistance consequently very small. Between two adjacent tape layers, the micro air gap forms a significant magnetic resistance, which causes the magnetic field lines to tend to stay within one tape layer. As a result, the magnetic flux is concentrated on the inner tape layers and the flux density decreases towards the outside (i.e. in the tape layers further out in the tape-wound ring core).

The magnetic saturation of the innermost tape layer has consequences for the flux guide piece 110/120, which is located in the central opening of the ring core 101 and connects (mechanically and magnetically) opposite (bottom) sides of the innermost tape layer 101a. When the innermost tape layer 101a is magnetically saturated, its (differential) relative permeability μᵣ (H)=1/μ₀·∂B/∂H (partial derivative of flux density B with respect to field strength H divided by vacuum permeability μ₀) drops massively, theoretically to one, which is why the magnetically saturated tape layer 101a behaves magnetically like an air gap. This means that magnetic saturation between the two ends of the flux guide 110/120 and the tape-wound ring core 101 creates “air gaps” with a gap width at least as large as the thickness of a tape layer. If the innermost ten tape layers were to saturate, the air gap width created by saturation of the inner tape layer(s) would be, for example, ten times the tape layer thickness.

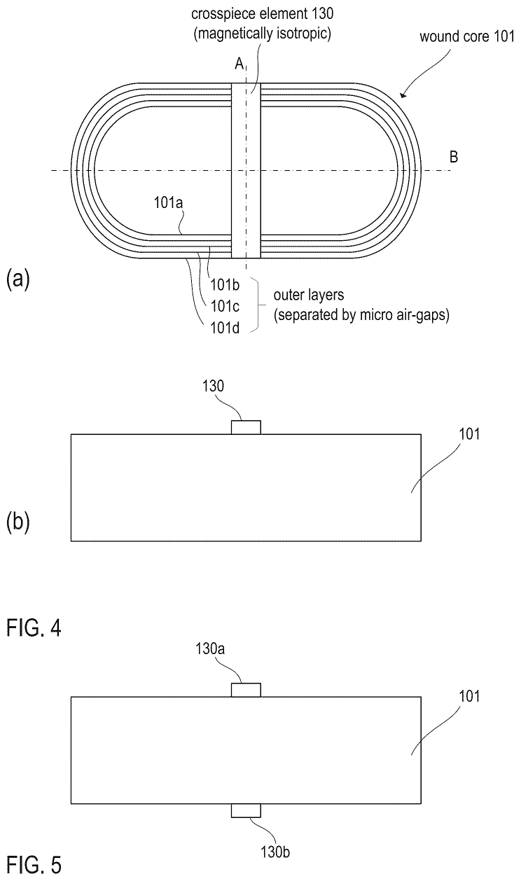

The increased effective air gap widths due to magnetic saturation of the innermost tape layers may lead to degraded DMC characteristics of filter-chokes with such ring core assemblies. In particular, magnetic saturation may negatively affect the performance (especially the inductance) of the filter choke. If high-frequency interference currents are superimposed on the DC electric currents (flowing through the conductors L₁ and L₂, cf. FIG. 2), wherein the magnetic flux caused by these currents impinges approximately perpendicularly on the tape planes, this leads to high parasitic eddy currents within the tape planes in the inner tape layers. The embodiments described in the following (cf. FIGS. 4-6) aim to improve this situation, i.e. to improve the magnetic properties of the ring core assembly (and of a filter choke constructed from it).

FIG. 3 illustrates a short segment of a ferromagnetic tape from which the tape-wound ring core 101 may be made. As mentioned, the tape may be a few 10 μm thick. The tape has a top side and a bottom side (top and bottom major surfaces). The height of the narrow sides corresponds to the thickness of the tape. When the tape is wound into a ring core, the bottom side of one winding rests on the top side of the winding below. As mentioned above, this results in an unavoidable (air) gap which causes the ring core 101 to have a lower magnetic resistance in the plane E of the tape than in a direction perpendicular to the tape plane E. In FIG. 3, this “direction of higher magnetic resistance” is visualized by an arrow.

FIG. 4 shows a first embodiment, where diagram (a) is a top view and diagram (b) is a side view. Similar to FIG. 2, the individual tape layers 101a-d shown are symbolic only. In fact the tape-wound ring core is wound from hundreds of windings of the ferromagnetic tape. Different from in FIG. 1, the flux guide piece/crosspiece 130 is not inserted into the central opening of the ring core 101, but contacts the side surfaces (referred to as narrow sides in FIG. 3) of the tape layers (in particular all tape layers) of the ring core 101. That is, the crosspiece 130 contacts the lateral side of the ring core and is not necessarily located within the central opening. For this reason, the crosspiece/flux guide piece may also be referred to as a “bridge”. The bridge 130 may be arranged along one of the symmetry axes A or B (in the example shown, along the symmetry axis A). The crosspiece/flux guide piece 130 may be made of an isotropic, ferromagnetic material with defined relative permeability μᵣ, for example of ferrite, of bonded (e.g. by means of phosphate) iron powder (nickel-iron or cobalt-iron powder) or of a metal powder alloy of a crystalline, amorphous or nanocrystalline alloy (e.g. nickel-iron or cobalt-iron).

The flux guide piece/crosspiece 130 may have the shape of a platelet with a rectangular contour. That is, geometrically, the platelet is an elongated cuboid with a very narrow base area and cross-sectional area. The crosspiece 130 may be held to the ring core by force-fit, for example, by means of a plastic housing surrounding the ring core and the crosspiece 130 (not shown in the figures). Other means of mounting the crosspiece 130 to the ring core 101 are also possible. Because the crosspiece/flux guide piece contacts the narrow sides of the tape layers 101a-d, the magnetic resistance between the ring core 101 and the flux guide piece 130 is reduced and, in particular, saturation of the innermost tape layer 101a does not lead to an increase in the air gap between the ring core 101 and the flux guide piece. The magnetic flux (field lines) may extend into the flux guide piece 130 in the tape plane E. As mentioned, the magnetic resistance in the tape plane E is lower than perpendicular to the tape plane, and significantly much lower eddy currents are generated upon penetration of an alternating (AC) field. Electrically, the ring core 101 and the crosspiece 130 may be insulated from each other.

FIG. 5 shows another embodiment in which the flux guide piece 130 is divided into two parts. That is, one crosspiece 130a is located on one side of the tape-wound ring core 101 and contacts (as in FIG. 4) the narrow sides of the tape layers, whereas another crosspiece 130b is arranged on the opposite side of the tape-wound ring core 101 (where it contacts the opposite narrow sides of the tape layers). The symmetrical design of the core assembly according to FIG. 5 further improves its magnetic properties.

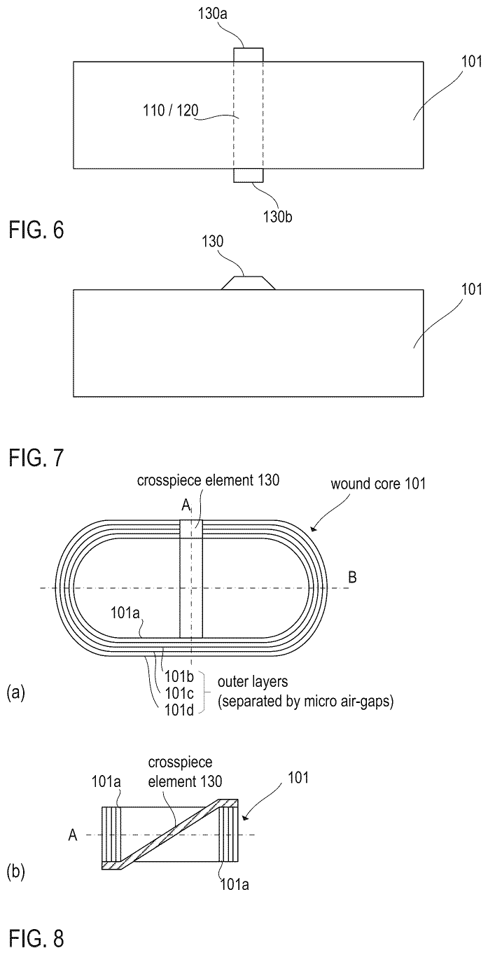

The example of FIG. 6 may be seen as a combination of the examples of FIGS. 5 and 1. Although the flux guide piece (composed of elements 110 and 120) in the central opening is not necessary, in combination with flux guide piece 130 as shown in FIG. 4 or flux guide pieces 130a and 130b as shown in FIG. 5, it may provide advantages in some applications with respect to the magnetic properties of the core assembly.

FIG. 7 illustrates, as a further example embodiment, a modification of the example of FIG. 4. According to FIG. 7, the crosspiece 130 does not have a rectangular cross-section (as in FIG. 4), but a trapezoidal cross-section, with the larger side surface of the crosspiece 130 contacting the end face of the ring core to further improve magnetic flux guidance. Furthermore, an electrically insulating foil may be arranged between the flux guide piece 130 and the ring core, so that the magnetically effective (air) gap between the ring core 101 and the flux guide piece 130 is determined by the thickness of the foil. This option is applicable to all of the examples described herein.

FIG. 8 illustrates another example embodiment in which the flux guide piece 130 is mounted laterally on the ring core 101 (e.g., by means of adhesive), but runs through the central opening of the core. That is, the two ends of the flux guide piece 130 are connected to opposite end faces of the ring core. As in the previous examples, the ends of the flux guide piece 130 contact a plurality of tape layers at their narrow side areas. Diagram (a) of FIG. 8 is a plan view (analogous to FIG. 4, diagram (a)) and diagram (b) of FIG. 8 is a cross-sectional view, wherein the section plane is along the axis of symmetry A and is normal to the axis of symmetry B.

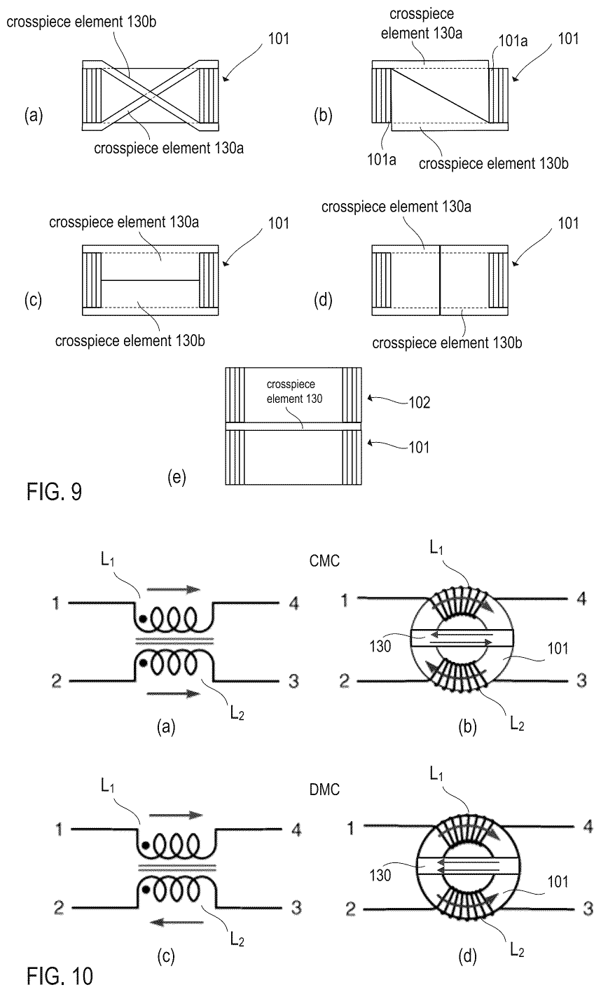

FIG. 9 shows some modifications and variations of the example of FIG. 8. All examples of FIG. 9 are cross-sectional views analogous to FIG. 8, diagram (b). In all examples shown in FIG. 9, two flux guide pieces 130a and 130b are combined. In the example shown in FIG. 9, diagram (a), both flow guide pieces extend obliquely through the central opening of the ring core 101, and the two ends of both flux guide pieces 130a and 130b are respectively connected to opposite end faces of the ring core. The variation shown in diagram (b) is similar to that shown in FIG. 6, wherein the element 130a has a wedge-shaped portion projecting into the central opening of the tape-wound ring core 101. In both diagrams (a) and (b), the elements 130a and 130b are the same, with the element 130b rotated 180° (with respect to the element 130a) and inserted into the ring core 101 from the other side.

The variants shown in diagrams (c) and (d) of FIG. 9 are the same when assembled. In both cases, the crosspieces 130a and 130b form a flux guide piece that is separated in the horizontal direction in diagram (c) and in the vertical direction in diagram (d). In another example, the elements 130a and 130b are formed in one piece.

The variant shown in FIG. 9, diagram (e), shows a ring core stack comprising a first ring core 101, a second ring core 102 and a crosspiece 130 arranged therebetween. The crosspiece 130 may be mounted on the ring core 101 in a manner similar to the example in FIG. 4 (e.g. by means of adhesive). On the other side of the crosspiece, the second ring core 102 is mounted in the same manner. The ring core stack together with the crosspiece may be arranged, for example, in a plastic housing. The other configurations of the crosspiece/flux guide piece shown here may also be used together with a ring core stack.

FIG. 10 schematically illustrates the application of the core assembly (ring core 101 plus flux guide piece 130) in filter chokes. Diagrams (a) and (b) relate to a common-mode choke (CMC), and diagrams (c) and (d) relate to a differential-mode choke (DMC). The operation of such filter chokes is known as such and is therefore not explained in more detail. The arrows in diagrams (a) and (c) symbolize the interference currents (and their direction) through the coils, and the arrows in diagrams (b) and (d) symbolize the corresponding direction of the resulting magnetic flux in the core assembly. Also evident from FIG. 6 is that the ring cores do not necessarily have to be oval, but can also be circular (or have some other shape).

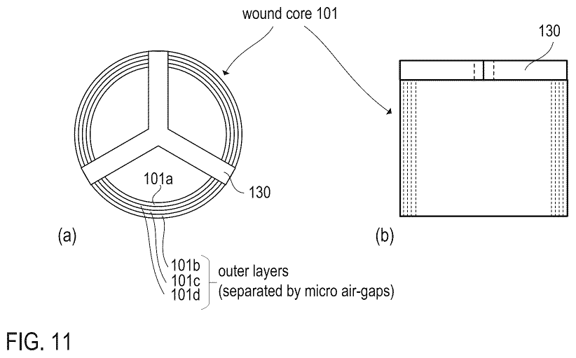

FIG. 11 shows a top view (diagram (a)) and side view (diagram (b)) of a ring core assembly for a three-phase filter choke. The concept can also be extended to more than three phases. In the example shown, the ring core is not oval but has a circular contour, i.e. the two opposite end faces of the ring core have the shape of a circular ring. According to FIG. 11, the flux guide piece 130 has three legs that are connected at the center of the circular ring. The three legs may be offset by 120°. In the example shown, the flow guide piece 130 is in one piece. The outer ends of the three legs touch the narrow sides of a plurality of tape layers. The flux guide piece divides the tape-wound ring core into three segments, wherein one or more coils may be wound around the tape-wound ring core 101 in each of the segments. The variations shown in FIG. 3-9 are also applicable to core assemblies for multiphase systems.

As mentioned, the flux guide pieces 130, 130a, 130b may be held by force-fit to the ring core, for example by means of a plastic housing surrounding the ring core and the flux guide piece(s). Alternatively, a flux guide piece may be firmly attached to one or both end faces of the ring core, for example by means of an adhesive. The adhesive may itself be magnetic, for example by containing ferromagnetic (e.g. iron or ferrite) particles. This further reduces the effective (magnetically effective) air gap between the flux guide and the narrow sides (see e.g. FIG. 3) of the tape of the tape-wound ring core, which is not perfectly flat due to the winding offset.

The narrow sides of the ferromagnetic tape from which the core is wound may be provided with an adhesive before the flux guide piece is placed on the core. Possible splinters of the tape material are thus bound with the adhesive.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to cover all possible conjunctive and disjunctive combinations, unless expressly noted otherwise. For example, the expression “A and/or B” should be interpreted to mean A but not B, B but not A, or both A and B. The expression “at least one of” should be interpreted in the same manner as “and/or”, unless expressly noted otherwise. For example, the expression “at least one of A and B” should be interpreted to mean A but not B, B but not A, or both A and B.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A ring core assembly, comprising:
a ring core wound from a ferromagnetic tape; and
at least one flux guide piece disposed laterally on the ring core so as to contact narrow sides of a plurality of tape layers of the ring core.

2. The ring core assembly of claim 1, wherein the ring core has an oval contour with two axes of symmetry.

3. The ring core assembly of claim 2, wherein the at least one flux guide piece is disposed along one of the two axes of symmetry and is electrically insulated from the ring core.

4. The ring core assembly of claim 1, wherein the at least one flux guide piece is attached to the ring core with an adhesive.

5. The ring core assembly of claim 1, wherein the at least one flux guide piece has a form of a plate that has an approximately rectangular contour.

6. The ring core assembly of claim 1, further comprising:
a further flux guide piece,
wherein the at least one flux guide piece and the further flux guide piece are arranged on opposite sides of the ring core.

7. The ring core assembly of claim 1, wherein the at least one flux guide piece is made of a ferromagnetic, magnetically isotropic material.

8. The ring core assembly of claim 1, wherein the ferromagnetic tape has a non-magnetic layer on a top and/or bottom side, such that the ring core has gaps between individual layers of the ferromagnetic tape, in which the non-magnetic layer is located.

9. The ring core assembly of claim 8, wherein the non-magnetic layer is made of a ceramic material.

10. The ring core assembly of claim 9, wherein the ceramic material comprises silicon oxide, manganese oxide, zirconium oxide, aluminum oxide, or a combination thereof.

11. The ring core assembly of claim 1, wherein the ferromagnetic tape is made of an iron alloy having a silicon content of more than 5 weight percent.

12. The ring core assembly of claim 1, wherein the at least one flux guide piece extends at least partially into a central opening of the ring core.

13. The ring core assembly of claim 1, wherein the at least one flux guide piece extends through a central opening of the ring core, wherein a first end of the at least one flux guide piece contacts the narrow sides of the plurality of tape layers on a first side of the ring core, and wherein a second end of the at least one flux guide piece contacts the narrow sides of the plurality of tape layers on a second side of the ring core.

14. The ring core assembly of claim 1, wherein the at least one flux guide comprises two members disposed on opposite sides of the ring core and projecting at least partially into a central opening of the ring core and contacting each other within the central opening.

15. The ring core assembly of claim 1, further comprising:
a further ring core,
wherein the at least one flux guide piece is disposed between the ring core and the further ring core so as to contact the narrow sides of a plurality of tape layers of the ring core and the further ring core.

16. A filter choke comprising:
a ring core wound from a ferromagnetic tape;
a first coil and a second coil wound around the ring core; and
at least one flux guide piece disposed between the first and second coils and laterally on the ring core so that the at least one flux guide piece contacts narrow sides of a plurality of tape layers of the ring core.

17. The filter choke of claim 16, further comprising:
a third coil,
wherein the at least one flux guide piece is disposed between the first and second coils, the first and third coils, and the second and third coils.
